(19) United States
(12) Patent Application Publication
(10) Pub. No.: US 2026/0004649 A1
(43) Pub. Date: Jan. 1, 2026

(54) FEED STITCHING AND CONSOLIDATED EVENT NOTIFICATION

(71) Applicant: THE CHAMBERLAIN GROUP LLC, OAK BROOK, IL (US)

(72) Inventors: Chris Selle, La Grange, IL (US); Injee Unshin, Philadephia, PA (US); Nathan Kopp, Edmonds, WA (US)

(21) Appl. No.: 18/758,975

(22) Filed: Jun. 28, 2024

(51) Int. Cl. G08B 21/18; G06F 3/0481; H04N 7/18

(52) U.S. Cl. CPC G08B 21/18; G06F 3/0481; H04N 7/181

(57) ABSTRACT

A non-transitory computer-readable medium storing instructions which, when executed by a processor, cause performance of a method of notifying a user of a consolidated event, the method including: receiving a first datum from a first source and a second datum from a second source, wherein the first and second sources are both connected to a network; processing information associated with the first datum to identify an event information associated with the first datum; processing information associated with the second datum to identify an event information associated with the second datum; comparing at least a portion of the event information associated with the first datum with at least a portion of the event information associated with the second datum; determining occurrence of a consolidated event based on the comparing; determining a notification based on the determined consolidated event; and causing transmission of the determined notification to a user device.

### FIELD

The present disclosure relates generally to event notification, and more particularly to consolidated event notifications generated by feed stitching data from one or more sources associated with a monitored environment.

### BACKGROUND

Modern sensors increasingly integrate with network environments to allow for monitoring of environments with finer levels of granularity. Homeowners may implement hardware, such as security cameras, electronic keypads, electronic locks, and other types of access control devices throughout an environment in order to capture activity within the environment. The implemented hardware can be in communication with a network that pushes notifications to a user device. As hardware integration becomes more ubiquitous and additional sources of data capture are introduced into the environment (or other environments associated with push notifications to the user device), the number of notifications pushed to the user device increases. However, each notification requires independent analysis by the user and must be combined by the user to construct context for the activity causing the notification.

Accordingly, improved notification systems and methods are desired in the art. In particular, notification systems and methods which provide consolidated event notification in view of feed stitching would be advantageous.

### BRIEF DESCRIPTION

Aspects and advantages of the invention in accordance with the present disclosure will be set forth in part in the following description, or may be obvious from the description, or may be learned through practice of the technology.

In accordance with one embodiment, a non-transitory computer-readable medium storing instructions which, when executed by a processor, cause performance of a method of notifying a user of a consolidated event is provided. The method includes receiving a first datum from a first source and a second datum from a second source, wherein the first and second sources are both connected to a network; processing information associated with the first datum to identify an event information associated with the first datum; processing information associated with the second datum to identify an event information associated with the second datum; comparing at least a portion of the event information associated with the first datum with at least a portion of the event information associated with the second datum; determining occurrence of a consolidated event based on the comparing; determining a notification based on the determined consolidated event; and causing transmission of the determined notification to a user device.

In accordance with another embodiment, a computer-implemented method is provided. The method includes receiving, at a processor, a first datum from a first source; determining, by the processor, a condition for causing transmission of a notification to a user device; receiving, at the processor, a second datum from the first source or a second source, the second datum received prior to satisfying the condition; processing, by the processor, information associated with the first datum and information associated with the second datum; generating, by the processor, one or more notifications to the user device based on the processing; and causing transmission of the one or more notifications to the user device.

In accordance with another embodiment, a non-transitory computer-readable medium storing instructions which, when executed by a processor, cause performance of a method of notifying a user of a consolidated event is provided. The method includes receiving a user request to view a feed history including data obtained from one or more sources; displaying the feed history on a user device, the feed history including a consolidated event, wherein the consolidated event comprises a plurality of separately captured events and a consolidated event tag descriptively identifying the consolidated event; receiving a user request to individually access the plurality of separately captured events included in the consolidated event; and expanding the consolidated event to display the separately captured events and consolidated event tags descriptively identifying each of the separately captured events.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a simplified view of a home including a front yard and a garage in accordance with embodiments of the present disclosure;

FIG. 2 is a schematic arrangement depicting a system in communication with one or more remote devices (e.g., a computing device and/or a remote server) in accordance with embodiments of the present disclosure;

FIG. 3 is a schematic of a computing device and/or a remote server in accordance with embodiments of the present disclosure;

FIG. 4 is a flowchart of a method of generating a consolidated event notification in accordance with embodiments of the present disclosure;

FIG. 5 is a flowchart of a method of generating one or more notifications to the user device in accordance with embodiments of the present disclosure;

FIG. 6 is a flowchart of a method of generating a consolidated event notification in accordance with embodiments of the present disclosure;

FIG. 7 is a flowchart of a method of generating a consolidated event notification in accordance with embodiments of the present disclosure;

FIG. 8 is view of a consolidated event notification generated on a display of a user device in accordance with embodiments of the present disclosure;

FIG. 9 is a view of a consolidated event notification generated on a display of a user device in accordance with embodiments of the present disclosure; and

FIG. 10 is a view of a feed history associated with a consolidated event notification generated on a display of a user device in accordance with embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, systems and methods described herein provide a user with one or more consolidated event notifications that allow the user to quickly and easily understand updates and context associated with a monitored environment.

Consolidated events are generally characterized as single events that generate separate datum. For example, when a vehicle arrives in a monitored environment, a video camera may capture initial arrival of the vehicle. Subsequently, one of the vehicle occupants may exit the vehicle, causing an additional datum to be captured. As the vehicle occupant attempts to gain access to a house or structure, the vehicle occupant may be forced to enter a passcode at a keypad, generating yet additional datum.

Traditionally, notifications associated with monitored environments were provided serially (i.e., individually in view of newly received datum) and required the user to parse through several different notifications to arrive at a contextual understanding of the status of the monitored environment. For example, a first notification was triggered (i.e., caused to be transmitted to the user) when a first source captured the vehicle arriving in the monitored environment and a second notification was triggered (i.e., caused to be transmitted to the user) when the first source or a second source captured further information associated with the vehicle or a vehicle occupant within the monitored environment. The first and second notifications remained at the user device and typically required the user to open both notifications to piece together contextual information to understand when a consolidated event occurred.

The use of consolidated event notification(s) provides greater contextual breadth and/or contextual clarity (as compared to non-consolidated event notifications) that allows the user to increase understanding of the status of the monitored environment without requiring the user to invest time and/or resources to reverse-construct the consolidated event from individual notifications. By generating a single, consolidated event notification, the user saves time and can more easily identify the status of the monitored area.

Systems and methods described herein rely on datum received from one or more sources, such as cameras, microphones, motion sensors, keypads, or the like that capture information from and/or about the environment. The datum can include a first datum and a second datum. The first and second datums may be captured by the same source or from different sources. For example, the first datum may be captured by a video camera at a property entrance and the second datum may be captured by a video keypad disposed at a home of the property. In accordance with an embodiment, the first and second datum can be processed, by one or more local and/or remote processors, to determine the occurrence of a consolidated event, i.e., a single event that spans multiple datum and for which traditionally multiple notifications would have been transmitted (pushed) to a user device. When a consolidated event is detected, the datum relating to the consolidated event and/or derivative information associated with the datum can be stitched together to generate a consolidated event notification including information captured from multiple different sources. Contextual information included in the consolidated event notification may provide information from which the user can quickly and easily understand aspects of the consolidated event.

The user can access additional information from the consolidated event notification. For example, the user may access a feed history (e.g., a video feed history) and/or a textual history of the consolidated event to view individual pieces of information compiled into the consolidated event notification. The user can further control or modify aspects of the consolidated event notification in view of particular requirements, aspects of the monitored environment, the source(s) used to capture the information associated with the environment, or the like. The user can customize their experience with the consolidated event notification to provide the most relevant information in a quick and easy-to-digest notification.

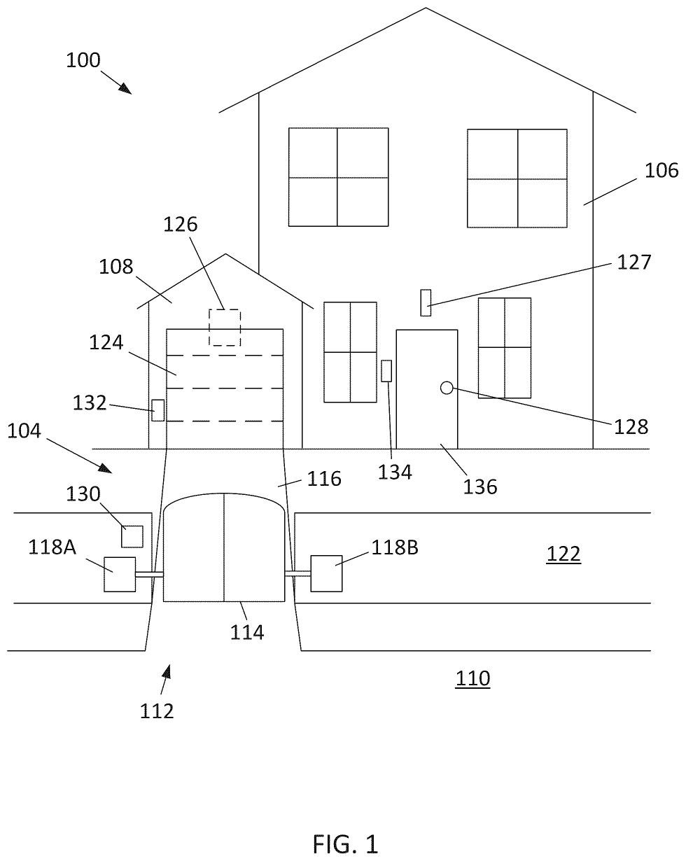

Referring now to the drawings, FIG. 1 illustrates an example environment 100 in which a system 102 in accordance with one or more embodiments described herein may be implemented. The depicted environment 100 includes a front yard 104 of a home 106 with an attached garage 108. However, it should be understood that the environment 100 may include other types of environments such as front yards 104 having different spatial arrangements (with or without garages 108), a backyard associated with the home 106, or the like. While embodiments described herein pertain to dwellings such as homes, it should be understood that consolidated events may be generated based on actions taken in other types of environments, such as commercial environments, industrial environments, or the like.

The depicted environment 100 is offset from a road 110. Vehicles travelling along the road 110 pass by the environment 100. A gated entrance 112 restricts access to the environment 100 from the road 110. The gated entrance 112 can include a movable barrier 114 (such as a gate) that is controllable between a closed position (as depicted) and an open position. With the movable barrier 114 in the closed position, vehicles are prevented from accessing the environment 100. For example, the movable barrier 114 can restrict access to a driveway 116 extending from the road 110 to the garage 108. With the movable barrier 114 in the open position, vehicles may pass through the gated entrance 112 and enter the environment 100, such as via the driveway 116.

In an embodiment, the movable barrier 114 is reconfigurable between the open and closed positions by a movable barrier operator 118 (referred to hereinafter as “the operator 118”). The operator 118 may include a single operating unit controlling, e.g., a single movable barrier 114, or a plurality of operating units, such as a first operator 118A and a second operator 118B, each controlling a portion of the movable barrier 114.

The environment 100 can further include other controllable appliances. For example, access to the garage 108 can be selectively restricted by a movable barrier 124. The movable barrier 124 can include, for example, a garage door coupled to a movable barrier operator 126 configured to control a position of the garage door between a closed position and an open position. In some instances, the movable barrier operator 126 can be in communication with the movable barrier operator 118 to provide simultaneous access to the front yard 104 (e.g., via the gated entrance 112) and to the garage 108 (e.g., via the movable barrier 124).

Other example appliances in the environment 100 include a light 127 and a door lock 128, which may be controllable. Yet further, appliances at the environment 100 can include a smart home controller, a climate system, a thermostat, a heating system, a cooling system, a security system, a telephone system, a television, a music device, an entertainment device, a media device, a lighting device, a microwave, a stove, a beverage center, a kitchen appliance, a hot tub controller, a sauna controller, a steam room controller, a pool controller, a window covering, a door lock, a proximity announcement device, an irrigation system, a mobile device, a beverage dispenser, and a pet management system. For some environments 100, there may also, or alternatively, be a loading dock system, an inventory management system, a commercial operation system, an industrial operation system, or the like.

In an embodiment, the environment 100 can be monitored by one or more information capture devices, such as camera(s), microphone(s), motion detector(s), proximity detector(s), weight sensor(s), keypad(s), etc. For example, FIG. 1 depicts a first source for capturing information (hereinafter referred to as “the first source 130”) disposed at the gated entrance 112, a second source for capturing information (hereinafter referred to as “the second source 132”) disposed in the front yard 104, and a third source for capturing information (hereinafter referred to as “the third source 134”) associated with a front door 136 of the home 106. It should be understood that the one or more information capture devices may include more or less sources that can be arranged similarly or differently within the environment 100. For example, the monitored environment 100 can include at least one information capture device, such as at least two information capture devices, such as at least three information capture devices, such as at least four information capture devices, such as at least five information capture devices.

Each information capture device (e.g., the first, second, and third sources 130, 132, 134) can capture information associated with a particular portion (or even all) of the environment 100. Each information capture device can capture information that can be used to notify a user, such as a homeowner, of a condition or status associated with the environment 100. For example, the first source 130 may include an image capture device that captures images and/or video feed of vehicles entering and exiting the driveway 116. The first source 130 may also include a user interface (such as a keypad) that receives information, such as a passcode, entered by an occupant of the vehicle prior to the first source 130 (or another component(s)) granting access to the vehicle through the gated entrance 112. The second source 132 may include an image capture device that captures images and/or video feed of the vehicle passing through the gated entrance 112 and moving along the driveway 116. The second source 132 may capture images and/or video feed of the vehicle stopping and one or more of the vehicle occupants exiting the vehicle. The second source 132 may detect spatial information, such as the relative parking location of the vehicle within the environment 100. The second source 132 may also capture images and/or video feed of one or more actions taken by the vehicle and/or any of the occupants of the vehicle. For example, the second source 132 can capture images and/or video feed of occupants exiting the vehicle, one or more packages handled by a delivery person, luggage being removed from the vehicle, one or more pets exiting the vehicle, or the like. The second source 132 may also include a user interface that receives information, such as a passcode, to grant access to the garage 108, e.g., using the movable barrier operator 126. The third source 134 can include a keypad lock that receives a passcode to selectively lock and unlock the door lock 128 and permit entry through the front door 136. In some embodiments, the third source 134 can also capture images and/or video feed at the environment associated with the front door 136. While the above examples provide visual and keypad data, yet other types of information capture devices can be used to capture information associated with the environment 100.

Separately detected, a typical notification from the first source 130 might be: “Motion detected”, “Vehicle arrived”, “Keypad Passcode—Accepted”, “James at gate”, or the like. Similarly, the notification from the second source 132 might be: “Motion detected”, “Vehicle arrived”, or the like. The notification from the third source 134 might be: “Keypad Passcode—Accepted”, “James at front door”, or the like. Separately pushed (transmitted) to the user device, the notifications generated by the first, second, and third sources 130, 132, 134 may read: “Motion detected. Vehicle arrived” (as detected by the first source 130), “Motion detected. Vehicle arrived” (as detected by the second source 132), and “James at the front door” (as detected by the third source 134). These notifications, while helpful in notifying the user of action within the environment 100, require the user to individually sort and piece together separate notification information to understand the status of the monitored environment and fail to quickly provide actionable contextual information. For instance, does the vehicle occupant need assistance carrying luggage, packages, children, etc.? Is the vehicle parked in an appropriate zone of the environment 100 or is the vehicle blocking access to an area (like the garage 108)? Does the identity of the person entering the passcode at the third source 134 match the expected (anticipated) person based on the entered passcode or is the person entering the passcode someone other than the expected person? It is contemplated herein that these and yet additional types of contextual information can be processed and transmitted (pushed) to the user with context by way of consolidated event notifications so that the user better understands the who, what, where, and when associated with a consolidated event.

Systems 102 in accordance with embodiments herein allow for stitching of information from the information capture devices (e.g., the first, second, and third sources 130, 132, 134) to generate a consolidated event notification. The term “stitching” is used throughout the disclosure to refer generally to the combination (potentially selective combination) of information to form a single consolidated narrative. The combination of information gathered by the first, second, and third sources 130, 132, 134 in the above example includes vehicle information (e.g., a license plate number; car make, model, year, color, unique identifiers, etc.), people information (e.g., number of people, identifying information associated with the people, etc.), and context information (e.g., the presence of luggage, a package, a pet, etc.). A consolidated event notification can be generated based on vehicle, people, and context information combined from the first, second, and third sources 130, 132, 134. The combined information incorporated into the consolidated event notification may be less than the entire information received from the first, second, and third sources 130, 132, 134. For example, based on receiving a passcode at the keypad of the first source 130 and a video feed captured by the second source 132, a consolidated event notification might be: “James arrived one minute ago with his wife and daughter. They might need help carrying luggage and a car seat.” The passcode entered at the first source 130 identifies the driver as James and processing and analysis of the video feed from the second source 132 determines the identity of the passengers and presence of items that may require assistance. Additional information may be captured by the first, second, and/or third sources 130, 132, 134 but deemed less important or redundant as compared to already-captured information. For example, the first source 130 is described as including a camera and a keypad, however, only the keypad information may be used in the consolidated event notification in view of superior datum captured by the camera of the second source 132. For instance, where the feed quality of the second source 132 is higher than the feed quality of the first source 130 (e.g., the second source 132 captures video in a relatively high quality like 1080p or 4K and the first source 130 captures video feed in a relatively low quality like 240p), the video feed from the second source 132 may be used as part of the consolidated event notification while the video feed from the first source 130 may be omitted. Of course, the video feed from the first source 130 may be used when/where video feed from the second source 132 is unavailable or where the second source 132 does not capture sufficient contextual information (or when the captured video feed from another source is better, etc.).

The greater the amount of information used to stitch together the consolidated event notification, the greater the probability that the consolidated event notification provides complete contextual information for the user to quickly and easily understand the status of the monitored environment. For instance, in the above example information is only received from the first and second sources 130, 132. In view of a further received passcode entered at the keypad of the third source 134 (where the passcode is associated with a person named “Tiffany”), the consolidated event notification might change to: “James arrived one minute ago with his wife and daughters. Tiffany is at the front door.” By further adding an image and/or video feed from the third source 134, the consolidated event notification might further change to: “James arrived one minute ago with his wife and daughters. Tiffany is standing at the front door and needs help with luggage.” The determination that Tiffany has luggage may be determined in view of the image and/or video feed.

Thus, a consolidated event notification as generated by the system 102 can describe context and information associated with a consolidated event rather than generate separate notifications, e.g., separate notifications for each received piece of information. Use of a single, consolidated event notification reduces the number of notifications received by the user (thereby mitigating notification fatigue) while providing additional context and information associated with the event. Rather than needing to individually review information obtained from each information capture device to determine context and scope of the event, the single consolidated event notification allows the user to quickly understand context and scope of the consolidated event, and thus better understand a state of the environment 100 without having to individually stitch together information themselves. The system 102 is described below in greater detail.

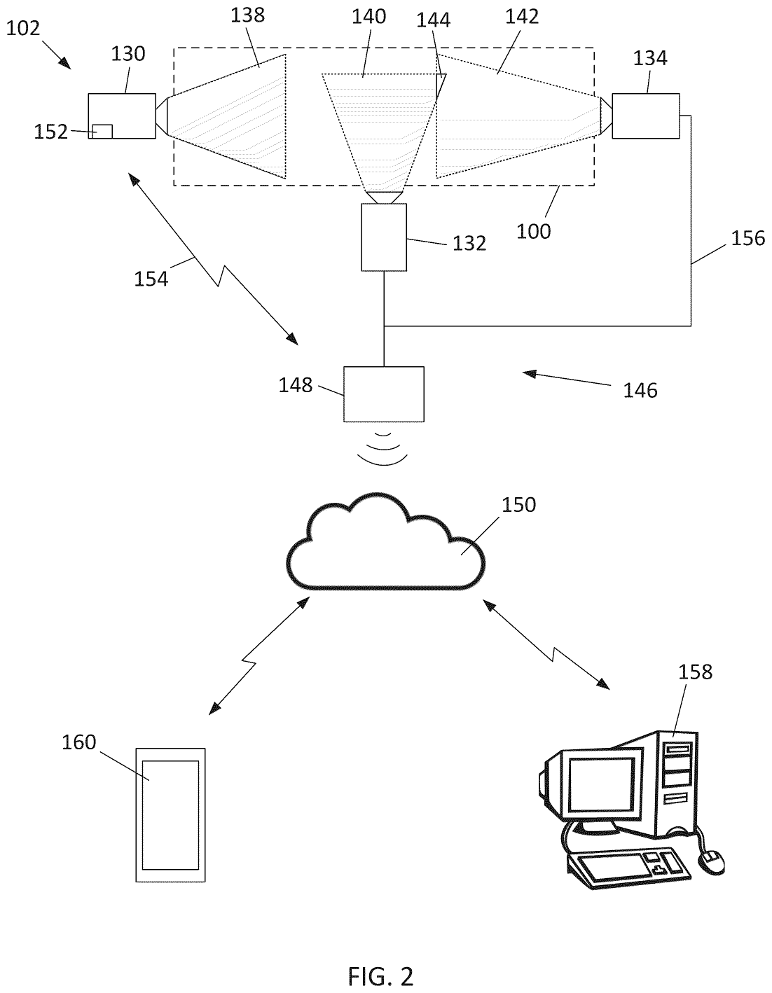

Referring to FIG. 2, the system 102 includes a plurality of information capture devices, such as the first source 130, the second source 132, and the third source 134. It should be understood that the number of information capture devices (i.e., information sources) capturing information associated with the environment 100 may be fewer or greater than that depicted. For example, in other instances, the environment 100 can be monitored by two information capture devices (e.g., the first source 130 and the second source 132), four information capture devices, five information capture devices, etc. The greater the number of information capture devices, the greater the opportunity to provide additional context and scope in generating the consolidated event notification described in greater detail below.

In an embodiment, at least two of the information capture devices can capture the same type of information (e.g., the at least two information capture devices can each include a camera that captures video feed). In another embodiment, at least two of the information capture devices can capture different types of information (e.g., one of the information capture devices can capture video feed and another of the information capture devices can capture a passcode entered at a keypad). Yet other types of information capture devices are possible.

The information capture devices can each capture information associated with at least a portion of the environment 100. For example, the first source 130 can include a camera with a first field of view (FOV) 138, the second source 132 can include a camera with a second FOV 140, and the third source 134 can include a camera with a third FOV 142. The FOVs 138, 140, 142 may be the same shape and/or size as one another or different from each other. In some instances, at least two of the FOVs 138, 140, 142 can overlap with one another. For example, the second and third FOVs 140 and 142 are depicted as overlapping in region 144 of the environment 100. In this regard, the second and third FOVs 140 and 142 can both capture information associated with the region 144 from different vantage points. In an embodiment, at least one of the FOVs 138, 140, 142 can capture information associated with the entire environment 100.

In some implementations, the information capture device(s) of the first, second, and/or third sources 130, 132, 134 can be static (stationary) and have a fixed FOV. In other implements, at least one of the information capture devices of the first, second, and/or third sources 130, 132, 134 can have an adjustable FOV. For example, at least one of the information capture devices can be coupled to a movable support structure that allows the at least one information capture device to rotate laterally and/or pan vertically to adjust the captured FOV. Moreover, the image capture device(s) may be configurable to zoom, tilt, or the like. In some implementations, a movably supported information capture device can be user-adjustable such that the user can adjust the FOV as desired.

In some instances, the information capture devices can be simultaneously installed at the environment 100, such as during construction of a building or as part of a single-phase retrofitting operation. In other instances, however, the information capture devices are installed at the environment 100 over a period of time, such as over a period of months or even years. It should be understood that systems 102 described herein may automatically incorporate datum from newly added information capture devices upon installation (or in response to an action taken during/after installation). For example, where an environment 100 was previously monitored by a single information capture device and a new information capture device is later added, the system 102 can automatically incorporate datum captured by the new information capture device into consolidated event notifications to improve contextual information provided in the consolidated event notification. In an embodiment, the system 102 can be configured to detect the presence of new information capture systems (i.e., information capture systems that were not previously connected to the system 102). In some instances, detection of a newly installed information capture system includes determining a type of information capture system associated with the new information capture system. Determining the type of information capture system can include detecting an information feed type (e.g., visual information, audible information, keypad information, etc). The system 102 can use algorithms, machine learning, a trained model, a reference (lookup) table, content rules, or the like to update aspects of the consolidated event notification in view of the determined type of information capture system installed.

During installation, each information capture device can be coupled to a local network access point 148, such as a wireless router. Some information capture devices may be wirelessly coupled to the local network access point 148. For example, the first source 130 is depicted as a wireless device having a transceiver 152 that wirelessly communicates 154 with the local network access point 148. Other information capture devices may be coupled to the local network access point 148, e.g., through a wired connection 156.

The local network access point 148 can wirelessly communicate with a remote server 158, a computing device 160 (e.g., a smartphone, tablet, laptop), or any other device using a network 150. In such a manner, information captured by the information capture devices (e.g., raw feed) may be communicated to the remote server 158, the computing device 160, or another device using the network 150.

The network 150 can be any type of network or combination of networks that allows for communication between devices. In some implementations, the network 150 can include one or more of a local area network, wide area network, secure network, cellular network, mesh network, peer-to-peer communication link and/or some combination thereof and can include any number of wired or wireless links. Communication over the network 150 can be accomplished, for instance, via a network interface using any type of protocol, protection scheme, encoding, format, packaging, etc.

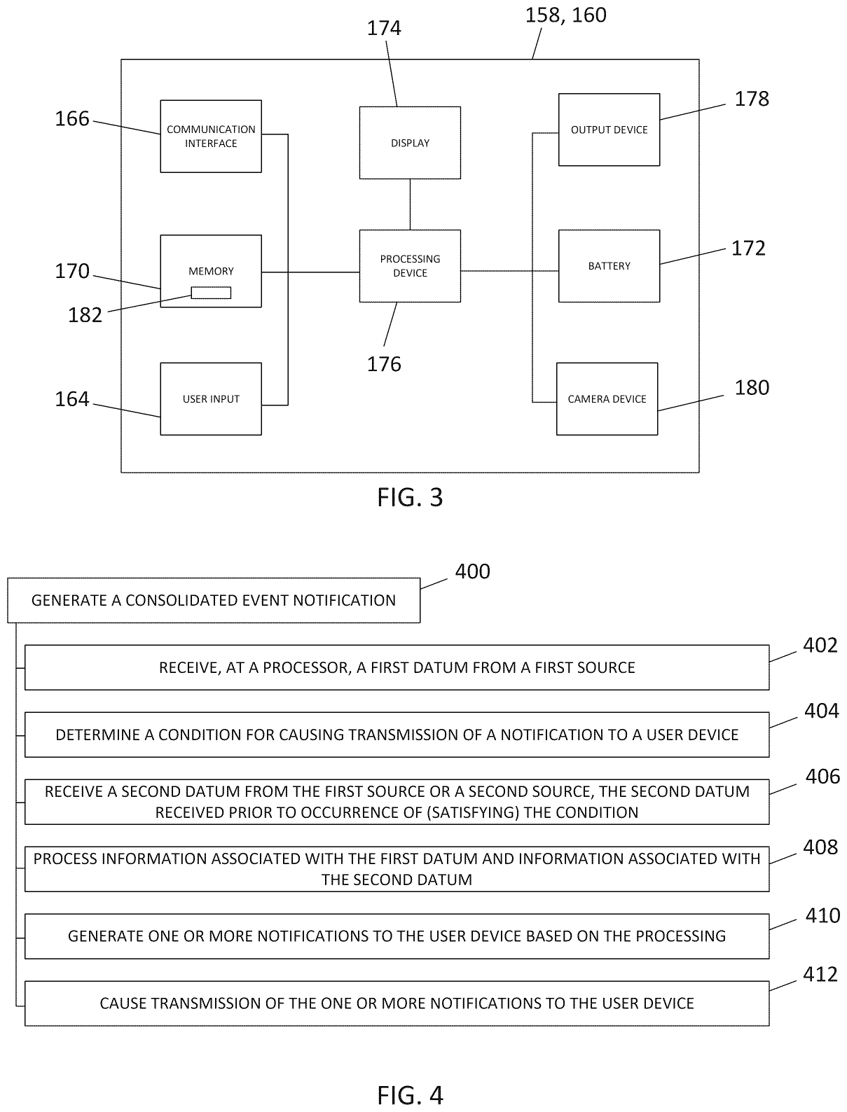

FIG. 3 illustrates a schematic of the computing device 160 and/or the remote server 158 in accordance with an example embodiment. As shown in FIG. 3, the computing device 160 or remote server 158 can include a user input 164, such as a touch screen, keypad, switch device, voice command software, or the like, a communication interface 166, a memory 170, a power source 172, which can be replaceable or rechargeable as desired, a display 174, and a processing device 176 controlling the operation thereof. As commonly understood, the components are connected by electrical pathways, such as wires, traces, circuit boards, and the like. The processing device 176 can include one or more processors. The processor(s) can be any suitable processing device (e.g., a control circuitry, a processor core, a microprocessor, an application specific integrated circuit, a field programmable gate array, a controller, a microcontroller, etc.) and can be one processor or a plurality of processors that are operatively connected. The memory 170 can include one or more non-transitory computer-readable storage media, such as RAM, ROM, EEPROM, EPROM, one or more memory devices, flash memory devices, etc., and combinations thereof. The memory 170 can store information that can be accessed by the processor(s). For instance, the memory 170 (e.g., one or more non-transitory computer-readable storage mediums, memory devices) can include computer-readable instructions 182 that can be executed by the processor(s). The instructions 182 can be software, firmware, or both written in any suitable programming language or can be implemented in firmware or hardware. Additionally, or alternatively, the instructions 182 can be executed in logically and/or virtually separate threads on processor(s). For example, the memory 170 can store instructions 182 that when executed by the processor(s) cause the processor(s) to perform operations such as any of the operations and functions as described herein.

The communication interface 166 can wirelessly communicate with the network 150. The communication interface 166 can include any circuits, components, software, etc. for communicating via one or more networks (e.g., the network 150). In some implementations, the communication interface 166 can include for example, one or more of a communications controller, receiver, transceiver, transmitter, port, conductors, software and/or hardware for communicating data/information. In an embodiment, the communication interface 166 can include a cellular antenna. In other embodiments, the communication interface 116 can include a WiFi transmitter/receiver, a local area network (LAN) communication protocol, or another type of communication interface 166.

The computing device 160 and/or remote server 158 can receive the captured information from the information capture devices (e.g., the first, second, and third sources 130, 132, 134) via the network 150. The computing device 160 and/or remote server 158 can process the received information and, where appropriate, determine the occurrence of a consolidated event, upon which the computing device 160 or remote server 158 can cause a consolidated event notification to be generated and transmitted to a user device as described below.

FIG. 4 is a flow chart of a method 400 of generating a consolidated event notification in accordance with an example embodiment of the present disclosure. In general, the method 400 will be described with reference to the system 102 and environment 100 as described above with reference to FIGS. 1 to 3. However, it should be understood that the method 400 may be performed in other types of environments and with systems including more or less (or different) features and/or attributes as described with respect to the system 102. The method 400 can be performed by a processor, such as the processor(s) of the processing device 176 of the remote server 158, computing device 160, and/or another electronic device. The processor(s) can communicate with non-transitory computer-readable medium storing instructions which, when executed by the processor(s), cause performance of the method 400 of generating a consolidated event notification. Although FIG. 4 depicts steps performed in a particular order for purposes of illustration and discussion, the method discussed herein is not limited to any particular order or arrangement. One skilled in the art, using the disclosure provided herein, will appreciate that various steps of the method 400 can be omitted, rearranged, combined, and/or adapted in various ways without deviating from the scope of the present disclosure.

The method 400 includes receiving 402, at a processor (such as the processor(s) of the processing device 176), a first datum from a first source. The first source is an information capture device associated with an environment (such as at the environment 100) and the first datum is information captured by the information capture device at the environment. By way of example, the first source can include: (i) an image capture device (e.g., a still frame camera or a video camera) and the first datum includes captured images and/or video feed, (ii) a keypad and the first datum includes a received passcode (optionally unique to each passcode recipient/holder), (iii) a microphone and the first datum includes audio captured from the environment, (iv) a motion detector and the first datum includes motion information (e.g., binary information, like whether an object is present and moving in the field of view, or variable information, like distance to object, size of object, speed of object, gait and/or stride patterns, etc.), (v) a proximity detector and the first datum includes proximity information, (vi) a weight sensor and the first datum includes detected weight, (vii) another type of information capture device, or any combination thereof. Information contained in the first datum can include, for example, image data, audio data, other types of sensor data, metadata (e.g., geographical information, time, source data, etc.), or the like. In an embodiment, the first source is selected from an image capture device, a wired keypad, a wireless keypad, a wired transmitter, a wireless transmitter, a smart device, a movable barrier operator, a smart lock, a motion detector, and a proximity detector. The first datum may be transmitted to the processor using a wired or wireless communication protocol. For example, the first datum may be transmitted to the processor of the remote server 158 or computing device 160 by the transceiver 152 or by the wired connection 156 through the network 150 in a manner as depicted in FIG. 2.

Once the first datum is received 402 at the processor, a decision is made whether to generate a notification based on the first datum or await potential further datum which might add richness and context to a generated event notification (i.e., a consolidated event notification). Conditional logic or the like can be established to determine whether to generate and transmit (push) the notification to a user device or to wait. In an embodiment, the method 400 further includes determining 404 a condition (e.g., conditional logic) for causing transmission of a notification to a user device in response to receiving the first datum. The user device can include the computing device 160 or another electronic device configured to notify the user of event information associated with the environment from which the first datum is captured. To prevent notification fatigue, e.g., as a result of receiving multiple notifications pertaining to a single event, absent the condition having already (previously) been satisfied, the notification is not caused to be transmitted to the user device. After the condition determined at step 404 has occurred (or is satisfied), the notification (or a different version of the notification, as described below) is caused to be transmitted to the user device. Thus, the condition can act as a trigger to cause transmission of the notification to the user device.

By way of non-limiting example, the condition can include a time delay (such as, e.g., 1 second, 2 seconds, 5 seconds, 10 seconds, 30 seconds, or even 60 seconds). A duration of time associated with the time delay may be selected by the user, automatically in view of one or more variables, or can be fixed. The condition may also, or alternatively, include receipt of additional datum, processing of additional datum, or even a specific condition based on information associated with the first datum. In some implementations, the condition is fixed. For example, the condition can include a fixed ten (10) second delay from the time of receiving 402 the first datum from the first source. In other implementations, the condition may be variable. For example, certain situations may require greater urgency and therefor trigger a shorter time delay condition whereas other situations deemed less urgent can trigger a longer time delay condition to allow for the acquisition of additional datum to generate richer (i.e., more contextually rich) consolidated event notifications. Yet further, the condition may vary based on the type of information capture device generating the first datum. For example, datum from a keypad may trigger a different condition than datum from a camera. Whereas datum from a camera might trigger a five (5) second waiting condition, datum from a keypad can trigger a ten (10) second waiting condition. This example is merely illustrative and may be adjusted and/or adjustable.

The method 400 further includes receiving 406 a second datum from the first source or a second source, the second datum received 406 prior to occurrence of (satisfying) the condition determined at step 404. Where the second datum is from the first source, the received 406 second datum can include the same type of information as the first datum previously received 402. For example, the first and second datum can both include video feeds captured at separate times. Alternatively, where the second datum is from the first source, the received 406 second datum can include a different type of information as compared to the first datum previously received 402. For example, the first source can include a video keypad where the first datum includes a video feed or a received passcode and the second datum includes the other of the video feed and received passcode.

In some instances, the second datum originates from a second source different than the first source. The second source can be the same type of information capture device or a different type of information capture device as compared to the first source. By way of non-limiting example, the second source can include: (i) a camera and the second datum includes captured images and/or video feed, (ii) a keypad and the second datum includes a received passcode (optionally unique to each passcode recipient/holder), (iii) a microphone and the second datum includes audio captured from the environment, (iv) a motion detector and the second datum includes motion information (e.g., binary information, like whether an object is present and moving in the field of view, or variable information, like distance to object, size of object, speed of object, gait and/or stride patterns, etc.), (v) a proximity detector and the second datum includes proximity information, (vi) a weight sensor and the second datum includes detected weight, (vii) another type of information capture device, or any combination thereof. In an embodiment, the second source is selected from an image capture device, a wired keypad, a wireless keypad, a wired transmitter, a wireless transmitter, a smart device, a movable barrier operator, a smart lock, a motion detector, and a proximity detector. The second datum may be transmitted to the processor using a wired or wireless communication protocol. For example, second datum may be transmitted to the processor of the remote server 158 or computing device 160 by the transceiver 152 or by the wired connection 156 using the network 150 in a manner as depicted in FIG. 2.

Where the condition is not yet satisfied upon receiving 406 the second datum, a notification regarding the first datum has not yet been caused to be transmitted to the user device. However, where the second datum is received 406 after the condition occurs (e.g., after a time delay of 5 seconds is completed), a notification associated with information provided by the first datum can optionally be caused to be transmitted to the user device. In some implementations, the notification associated with the information provided by the first datum may be caused to be recalled, e.g., upon receiving 406 the second datum or upon occurrence a further step associated with the method 400, such as upon processing the datum (described below). In this regard, notifications generated by the method 400 can be recalled and replaced by updated notifications, such as by a consolidated event notification.

The method 400 can further include processing 408 information associated with the first datum and information associated with the second datum. In some instances, information associated with the first and second datum are separately processed 408. For example, information associated with the first datum can be processed 408 upon receipt 402 whereas the information associated with the second datum may not be processed 408 until receipt 406 at a later time. Processing 408 of the first datum may be completed prior to receiving 406 the second datum. In other instances, the first and second datum (or portions thereof) can be processed 408 together. The first and second datum can be processed 408 by a same processor or a same set of processors or by different processors.

Processing 408 information associated with the first datum and information associated with the second datum may allow the first and second datum (or portions thereof) to be stitched together (i.e., merged) to form a single, consolidated event notification. For example, where processing 408 is indicative of a consolidated event, the information from both the first and second datum can be combined to notify the user of the consolidated event as described below.

Datum from cameras (i.e., images and/or video feed) can be processed 408 using one or more image processing techniques. Image processing techniques are not described in detail herein, but are generally known to include image enhancement (e.g., bicubic interpolation, patch extraction, non-linear mapping, and reconstruction), image segmentation (e.g., binary thresholding, multi-level thresholding, a positioning and focus network including a positioning module for object detection and a focus module to identify objects), object detection (e.g., algorithms, deep learning models such as convolutional neural networks (CNNs) like Faster R-CNN (Region-based Convolutional Neural Network)), image compression (e.g., deep learning compression, autoencoders), image manipulation (e.g., Neural Style Transfer), and image-to-image translation (e.g., a conditional GAN model). These and other image processing techniques can be used to process 408 images and/or camera feed to identify context associated with the received 402 and 406 first and second datum.

Datum from other types of information capture devices may be processed according to their data type. For example, information entered at a keypad may be referenced to a user access list which includes a list of passcodes each associated with an approved party (e.g., a spouse, a child, a family member, a neighbor, etc.). Passcode attempts received at the keypad can be compared to the user access list not only to determine whether access should be granted, but also to determine an identity of the party entering the passcode. Similarly, data from motion detectors may be used to determine gait or stride information associated with a person moving within the environment, the presence of objects (e.g., packages, luggage, car seats, strollers, bicycles, etc.) within the environment, vehicle information, or the like.

The processed 408 information (or portions of processed 408 information such as identified context information) can be stored in memory, such as the memory 170 of the remote server 158 or computing device 160 or another memory storage device, to be accessed for later use and reference.

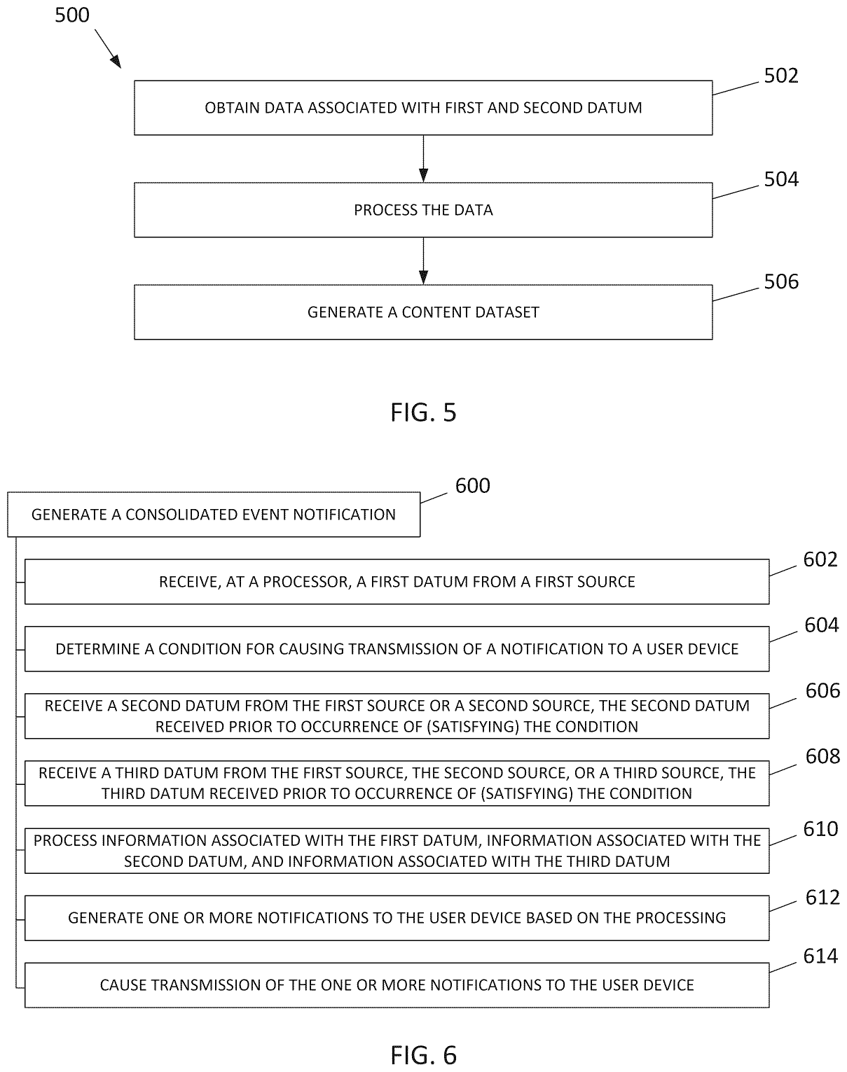

The method 400 can further include generating 410 one or more notifications to be transmitted to the user device based at least in part on the processing performed at step 408. FIG. 5 depicts a flow chart diagram of an example method 500 of generating 410 the notification(s) based on the processing performed at step 408 in FIG. 4. Although FIG. 5 depicts steps performed in a particular order for purposes of illustration and discussion, the methods of the present disclosure are not limited to the particularly illustrated order or arrangement. The various steps of the method 500 can be omitted, rearranged, combined, and/or adapted in various ways without deviating from the scope of the present disclosure.

At step 502, one or more processors can obtain data associated with the first and second datum. The obtained data can include, for example, context information and raw data as processed at step 408. Context information can be descriptive of a context associated with the monitored environment, identified parties within the environment, or the like. The context information can include time information, location information, a data log, and/or other contextual information. The contextual information may include a record of a particular event of note (e.g., detected arrival of a vehicle, operation of a movable barrier operator, information received at a keypad, etc.). Obtained raw data can include video feed, still images, audio data, motion tracking data, and the like.

At step 504, the processor(s) can process the obtained datum (or some of the obtained datum), e.g., with a generative model, to determine a consolidated event associated with the datum. Several methods are contemplating for processing the data at step 504, including comparing relatedness of the datum, using generative modeling, and the like. In an embodiment processing the obtained data is performed based on a relatedness of the contextual information associated with the datum. For instance, processing the data at step 504 can include analyzing the relatedness of contextual information associated with first and second datum, and determining a consolidated event type based on the contextual information where the analyzed relatedness exceeds a threshold. The threshold may be preset (e.g., by a manufacturer or installer) or manually by the user. The threshold may represent a stitching coefficient above which stitching is desired and below which stitching is not performed. Where the relatedness threshold is exceeded by the first and second datum, the processing at step 504 can determine the occurrence of the consolidated event. Where the determined relatedness is below the threshold, the first and second datum can be determined to be part of separate, isolated events and not part of a single, consolidated event warranting a consolidated event notification.

At step 506, the processor(s) can generate a content dataset associated with the consolidated event. The content dataset can include visual datum and/or one or more other types of datum (such as contextual information). The contextual information can be descriptive of the visual datum. The visual datum may include image datum, text datum, and/or other datum. The content dataset may be processed by one or more machine-learned models, algorithms, or using another technique to generate a consolidated event description. The consolidated event description can provide a context rich description of the environment and/or actions occurring in the environment. The consolidated event description may be stored with the content dataset.

The consolidated event notification may include visual data that is part of the content dataset. The visual data can include an object classification, a content grouping (e.g., a grouping association with one or more related datums), and/or a model-generated description that includes contextual information for explaining the environmental and/or actions occurring in the environment. The consolidated event notification (or information associated therewith) may be processed with a generative model (e.g., a large language model (e.g., a vision language model)) to determine one or more labels for the consolidated event notification.

Referring again to FIG. 4, the method 400 can further include causing 412 transmission of the one or more notifications generated at step 410 to the user device. Causing 412 transmission can be performed by the processor(s), e.g., in response to generating a content dataset at step 506 in FIG. 5. The transmitted consolidated event notification can appear on the display 174 of the computing device 160.

The transmitted notification can include any one or more of a consolidated event notification label (e.g., textual information such as “James arrived.”), the consolidated event description (e.g., textual information such as “James parked on the driveway.”), visual data (e.g., a video feed captured by one or more of the sources), or the like. The user can access additional information relating to the consolidated event notification, for example by selecting the notification or a portion thereof.

FIG. 6 is a flow chart of a method 600 of generating a consolidated event notification in accordance with an example embodiment of the present disclosure. The method 600 may be substantially similar to the method 400, however, rather than generating a notification based on receipt 402 and 406 of first and second datum, the method 600 is configured to generate the consolidated event notification based on receiving an additional third datum. The method 600 can be performed by a processor, such as the processor(s) of the processing device 176 of the remote server 158, computing device 160, and/or another electronic device. The processor(s) can communicate with non-transitory computer-readable medium storing instructions which, when executed by the processor(s), cause performance of the method 600 of generating a consolidated event notification. Although FIG. 6 depicts steps performed in a particular order for purposes of illustration and discussion, the method discussed herein is not limited to any particular order or arrangement. One skilled in the art, using the disclosure provided herein, will appreciate that various steps of the method 600 can be omitted, rearranged, combined, and/or adapted in various ways without deviating from the scope of the present disclosure.

The method 600 can include receiving 602, at a processor, a first datum from a first source. Receiving 602 the first datum may occur in a substantially similar way to receiving 402 the first datum described above with respect to FIG. 4. The method 600 can further include determining 604 a condition for causing transmission of a notification to a user device. Determining 604 the condition may occur in a substantially similar way to determining 404 the condition described above with respect to FIG. 4. The method 600 can further include receiving 606 a second datum from the first source or a second source, the second datum received prior to occurrence of the condition. Receiving 606 the second datum may occur in a substantially similar way to receiving 406 the second datum described above with respect to FIG. 4. The method 600 can further include receiving 608 a third datum from the first source, the second source, or a third source, the third datum received prior to occurrence of the condition. The method 600 can further include processing 610 information associated with the first datum, information associated with the second datum, and information associated with the third datum. Processing 610 the information may occur in a substantially similar way to processing 408 the information as described above with respect to FIG. 4; however, the processed information includes the additional third datum. The method 600 can further include generating 612 one or more notifications to the user device based on the processing performed at step 610. Generating 612 the one or more notifications may occur in a substantially similar way to generating 410 the one or more notifications as described above with respect to FIG. 4. The method 600 can further include causing 614 transmission of the one or more notifications to the user device. Causing 614 the transmission may occur in a substantially similar way to causing 412 the transmission as described above with respect to FIG. 4. It should be understood that additional sources and datum (e.g., a fourth datum, a fifth datum, etc.) may be processed and relevant portions thereof may be captured in the transmitted notification. Additional sources and datum may allow for a more context rich description of the environment.

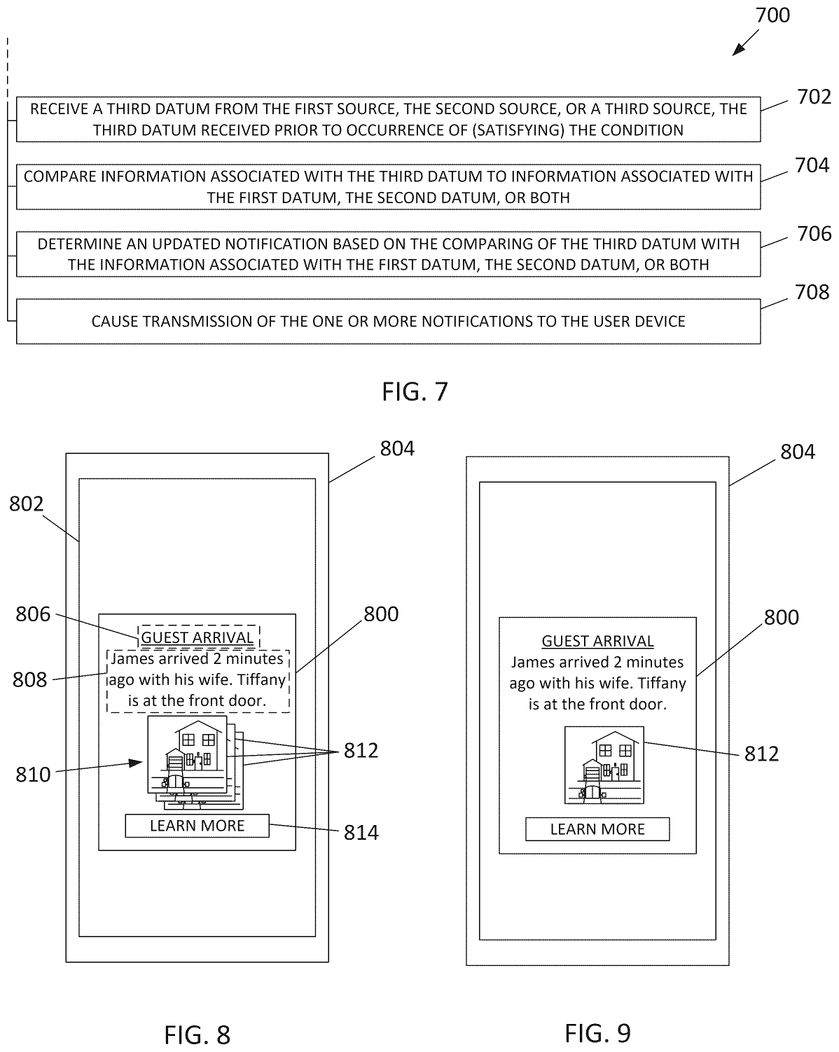

In an embodiment, the third datum received at step 608 may occur after the condition. As such, the third datum is received after one or more notifications have already been transmitted to the user device. FIG. 7 is a flow chart of an alternate method 700 of generating a consolidated event notification in accordance with an example embodiment of the present disclosure occurring after step 606 in FIG. 6 where the third datum is received after the condition determined at step 604. One skilled in the art, using the disclosure provided herein, will appreciate that various steps of the method 700 can be omitted, rearranged, combined, and/or adapted in various ways without deviating from the scope of the present disclosure.

After receiving the second datum at step 606 (FIG. 6), the condition may trigger, causing transmission of a notification based on processing of the received 602 and 606 first and second datum. Subsequently, the method 700 can include receiving 702 a third datum from the first source, the second source, or a third source, the third datum received after occurrence of the condition.

In some instances, the third datum originates from a third source different than the first and second sources. The third source can be the same type of information capture device or a different type of information capture device as compared to the first and/or second source. By way of non-limiting example, the third source can include: (i) a camera and the second datum includes captured images and/or video feed, (ii) a keypad and the second datum includes a received passcode (optionally unique to each passcode recipient/holder), (iii) a microphone and the second datum includes audio captured from the environment, (iv) a motion detector and the second datum includes motion information (e.g., binary information, like whether an object is present and moving in the field of view, or variable information, like distance to object, size of object, speed of object, gait and/or stride patterns, etc.), (v) a proximity detector and the second datum includes proximity information, (vi) a weight sensor and the second datum includes detected weight, (vii) another type of information capture device, or any combination thereof. In an embodiment, the third source is selected from an image capture device, a wired keypad, a wireless keypad, a wired transmitter, a wireless transmitter, a smart device, a movable barrier operator, a smart lock, a motion detector, and a proximity detector. The third datum may be transmitted to the processor using a wired or wireless communication protocol. For example, third datum may be transmitted to the processor of the remote server 158 or computing device 160 by the transceiver 152 or by the wired connection 156 using the network 150 in a manner as depicted in FIG. 2.

The method 700 can further include comparing 704 information associated with the third datum with the information associated with the first datum, the second datum, or both. The method 700 can further include determining 706 an updated notification based on the comparing performed at step 704. For example, where the third datum provides additional context and/or better image quality than that received in the first or second datums, the determination 706 may be to update the notification. However, where the third datum provides no additional context and the image quality is the same, or worse than, the image quality of the first or second datums, the determination 706 may be to not update the notification. The method 700 can further include causing 708 transmission of the updated notification to the user device.

FIGS. 8 and 9 illustrate consolidated event notifications 800 as seen on a display 802 of a user device 804 in accordance with an example embodiment of the present disclosure.

The user device 804 can include a user input (such as a touch screen, keypad, switch device, voice command software, or the like), a communication interface, a memory, a power source (which can be replaceable or rechargeable as desired), a display, and a processing device controlling the operation thereof. As commonly understood, the components are connected by electrical pathways, such as wires, traces, circuit boards, and the like. The processing device can include one or more processors. The processor(s) can be any suitable processing device (e.g., a control circuitry, a processor core, a microprocessor, an application specific integrated circuit, a field programmable gate array, a controller, a microcontroller, etc.) and can be one processor or a plurality of processors that are operatively connected. The memory can include one or more non-transitory computer-readable storage media, such as RAM, ROM, EEPROM, EPROM, one or more memory devices, flash memory devices, etc., and combinations thereof. The memory can store information that can be accessed by the processor(s). For instance, the memory (e.g., one or more non-transitory computer-readable storage mediums, memory devices) can include computer-readable instructions that can be executed by the processor(s). The instructions can be software, firmware, or both written in any suitable programming language or can be implemented in firmware or hardware. Additionally, or alternatively, the instructions can be executed in logically and/or virtually separate threads on processor(s). For example, the memory can store instructions that when executed by the processor(s) cause the processor(s) to perform operations such as any of the operations and functions as described herein.

The consolidated event notification 800 can include information such as a label 806 and contextual information 808. The consolidated event notification 800 can further, or alternatively, include raw data 810 such as visual datum from one of the sources. The raw data 810 may be arranged in a stacked arrangement of cards 812 (such as depicted in FIG. 8), as a single card 812 (such as depicted in FIG. 9), or in another format or configuration. In some implementations, the consolidated event notification 800 may further include a user-selectable button 814, such as a radio button or slidable icon, which allows a user to selectively access additional information associated with the consolidated event notification 800. The additional information can include, for example a feed history such as described below.

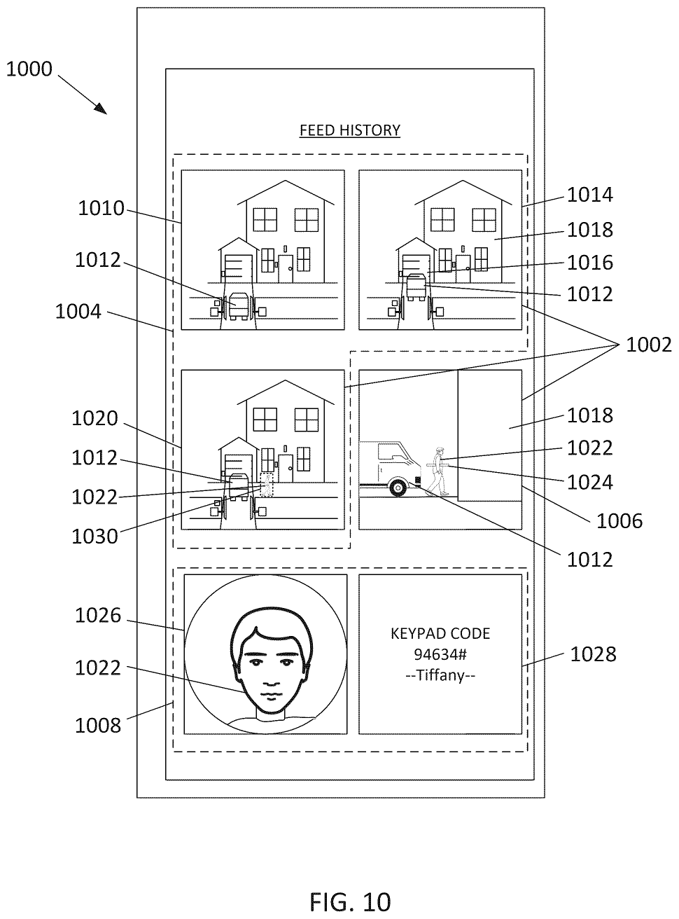

FIG. 10 illustrates a feed history 1000 as seen when a user selects the button 814 or otherwise requests access to additional information associated with the consolidated event notification 800 in accordance with an example embodiment. It should be understood that the spatial arrangement of icons, windows, elements, and the like on the display 802 (FIG. 8) may differ from that depicted in FIG. 10. For instance, the feed history 1000 may be organized differently, include more or less visible history, include one or more user accessible features, or the like.

As depicted in FIG. 10, the feed history 1000 can include separate cards 1002, each associated with one of the datum or information capture devices. For example, the cards 1002 include a first set of cards 1004, a second card 1006, and a third set of cards 1008. The first set of cards 1004 are captured by a first information capture device at different times. The first card 1010 of the first set of cards 1004 may be captured by a first information capture device when a vehicle 1012 arrives at the environment. The second card 1014 of the first set of cards 1004 may be captured by the first information capture device when the vehicle 1012 arrives at a garage 1016 associated with a home 1018 in the environment. The third card 1020 of the first set of cards 1004 may be captured by the first information capture device when a vehicle occupant 1022 exits the vehicle 1012. In some instances, the first, second, and third cards 1010, 1014, 1020 may all occur within a same video clip captured by the first source. In other instances, the first, second, and third cards 1010, 1014, 1020 may be captured in separate video clips. For example, where the vehicle 1012 arrives at the garage 1016 and the driver waits to exit the vehicle 1012 for an extended period of time (e.g., as a result of grabbing a package or checking a delivery address), motion activated capture by the first information capture device may conclude, resulting in the driver's exit from the vehicle 1012 triggering capture of a separate video clip. Regardless, the video clip(s) (or other datum) can be broken into smaller segments for display on the feed history 1000.

The second card 1006 is a still frame image captured by a second information capture device (e.g., a still frame camera). The second card 1006 depicts the vehicle occupant 1022 walking from the vehicle 1012 towards the home 1018 with a package 1014. The third set of cards 1008 is captured by a third information capture device (e.g., a video keypad). The third set of cards 1008 includes a first card 1026 and a second card 1028. The first card 1026 of the third set of cards 1008 can include a video feed captured by a camera of the third information capture device as the vehicle occupant 1022 approaches. The first card 1026 of the third set of cards 1008 is depicted capturing the face of the vehicle occupant 1022 prior to entering a passcode at a keypad of the third information capture device. The second card 1028 of the third set of cards 1008 includes the entered passcode as received at the keypad. If additional information is received at the keypad (e.g., an unsuccessful passcode entry attempt), the additional information may be displayed in the second card 1028 or yet another card (not illustrated). Yet additional information may be displayed on the feed history 1000.

In an embodiment, the user can select (e.g., click) on one of the cards displayed in the feed history 1000 to access additional information associated with that card. The additional information associated with that card may be viewed as traditionally seen in non-consolidated event notifications or seen with a different format. However, the information associated with the card may be constrained to include only the information associated with that particular datum received from that particular source. The user may be able to cycle between different datums and sources, e.g., using a left arrow and a right arrow, an upward-facing arrow and a downward-facing arrow, by swiping between the cards, or the like. In an embodiment, the particular card currently being viewed may appear as a top card on the stack, allowing the user to swipe between cards. In some instances, the cards can be arranged in a carousel that allows the user to rotate/move between different cards. Yet other spatial embodiments and layouts are contemplated herein.

In some implementations, the user may be able to track a particular portion of the environment between different datum and/or different sources. For example, the user may want to track the vehicle occupant 1022 as he or she moves between different datum and sources. To track the vehicle occupant 1022, the user can select the vehicle occupant 1022, for example by selecting the vehicle occupant 1022 on the display 802 (FIG. 8). A box 1030 may appear around the vehicle occupant 1022. The user may be able to accept or adjust the box 1030 to correspond with a particular object/person for which tracking is desired. The vehicle occupant 1022 can be identified (e.g., by the one or more processors executing the system 102) throughout the information received from the sources, i.e., identified where he or she shows up in the datum. The feed history 1000 (or another view) can then show all datum (or a portion of the datum) where the vehicle occupant 1022 was captured. Using this information, the user may be able to determine how the vehicle occupant 1022 moved within the environment. For example, the user can determine whether the vehicle occupant 1022 walked directly from the vehicle 1012 to the home 1018 or attempted to go around the home 1018 to a backyard (not illustrated). Capturing such information may allow the user to quickly determine risk associated with the presence of the vehicle occupant 1022. Additionally, the user can quickly determine whether the vehicle occupant 1022 took any action within the environment that requires attention.

Systems, methods, and components described herein provide a user with context-rich notifications associated with a monitored environment that allow for quick and easy understanding and updating. Using prompts, raw data, and contextual information, a consolidated event notification can be generated and transmitted to the user. The user can curate and customize the scope of the generated notification and/or allow for automatic generation, e.g., using machine learned programming and the like. Systems, methods, and components described herein provide heightened levels of security within a monitored environment by reducing missed notifications resulting from notification fatigue and by alerting users to potential problems with contextual information. Rather than having to open individual notifications or raw data associated with traditional, single-event notifications, the user can quickly glance at a user device and determine whether further review is necessary in view of the consolidated event notification. This reduces user exhaustion and simultaneously increases speed of understanding and adapting to changing environments and situations.

Further aspects of the invention are provided by one or more of the following embodiments:
Embodiment 1. A non-transitory computer-readable medium storing instructions which, when executed by a processor, cause performance of a method of notifying a user of a consolidated event, the method comprising: receiving a first datum from a first source and a second datum from a second source, wherein the first and second sources are both connected to a network; processing information associated with the first datum to identify an event information associated with the first datum; processing information associated with the second datum to identify an event information associated with the second datum; comparing at least a portion of the event information associated with the first datum with at least a portion of the event information associated with the second datum; determining occurrence of a consolidated event based on the comparing; determining a notification based on the determined consolidated event; and causing transmission of the determined notification to a user device.
Embodiment 2. The non-transitory computer-readable medium of any one or more of the embodiments, wherein the method further comprises: receiving a third datum from a third source, wherein the third source is connected to the user network; processing information associated with the third datum to identify an event information associated with the third datum; and comparing at least a portion of the event information associated with the third datum with at least a portion of the event information associated with each of the first and second datum.
Embodiment 3. The non-transitory computer-readable medium of any one or more of the embodiments, wherein the notification identifies a contextual information associated with the determined consolidated event, and wherein a detail level of the contextual information is different based on which combination of the first, second, and third datum is received and processed.
Embodiment 4. The non-transitory computer-readable medium of any one or more of the embodiments, wherein the first source is selected from a group consisting of an image capture device, a wired keypad, a wireless keypad, a wired transmitter, a wireless transmitter, a smart device, a movable barrier operator, a smart lock, a motion detector, and a proximity detector, and wherein the second source is selected from a group consisting of an image capture device, a wired keypad, a wireless keypad, a wired transmitter, a wireless transmitter, a smart device, a movable barrier operator, a smart lock, a motion detector, and a proximity detector.
Embodiment 5. The non-transitory computer-readable medium of any one or more of the embodiments, wherein the first source comprises a first type of device, and wherein the second source comprises a second type of device different than the first type of device.
Embodiment 6. The non-transitory computer-readable medium of any one or more of the embodiments, wherein the event information associated with the first datum and the second datum each includes a contextual information, wherein comparing the event information associated with the first and second datum comprises determining a relatedness of the contextual information associated with the first datum with the contextual information associated with the second datum; and wherein determining occurrence of the consolidated event based on the comparing comprises: analyzing the relatedness of the contextual information associated with the first and second datum; and determining a consolidated event type based on the contextual information where the analyzed relatedness exceeds a threshold.
Embodiment 7. The non-transitory computer-readable medium of any one or more of the embodiments, wherein the determined notification is generated by comparing the consolidated event type to a lookup table or content rules.
Embodiment 8. The non-transitory computer-readable medium of any one or more of the embodiments, wherein the method further comprises: selecting one of the first or second datum in view of a selection criteria; and causing transmission of at least a portion of the selected datum to the user device.
Embodiment 9. The non-transitory computer-readable medium of any one or more of the embodiments, wherein the first datum is received prior to the second datum, and wherein the method further comprises: determining the event information associated with the first datum in response to receiving the first datum; determining a waiting period associated with a duration of time between receiving the first datum and an anticipated receipt of the second datum in view of the determined event information; and waiting for the waiting period to expire without causing transmission of the determined notification to the user device.
Embodiment 10. The non-transitory computer-readable medium of any one or more of the embodiments, further comprising: determining a notification based on the event information associated with the first datum; and causing transmission of the notification based on the event information associated with the first datum after expiration of the waiting period without receipt of the second datum.
Embodiment 11. A computer-implemented method comprising: receiving, at a processor, a first datum from a first source; determining, by the processor, a condition for causing transmission of a notification to a user device; receiving, at the processor, a second datum from the first source or a second source, the second datum received prior to satisfying the condition; processing, by the processor, information associated with the first datum and information associated with the second datum; generating, by the processor, one or more notifications to the user device based on the processing; and causing transmission of the one or more notifications to the user device.
Embodiment 12. The computer-implemented method of any one or more of the embodiments, wherein determining the condition comprises determining a duration of time to wait prior to determining the one or more notifications, and wherein the second datum is received prior to expiration of the duration of time.
Embodiment 13. The computer-implemented method of any one or more of the embodiments, further comprising: receiving, at the processor, a third datum from the first source, the second source, or a third source, wherein the third datum is received after the condition; comparing, by the processor, information associated with the third datum with the information associated with the first datum, the second datum, or both; and determining, by the processor, an updated notification based on the comparing of the third datum with the information associated with the first datum, the second datum, or both; causing transmission of the updated notification to the user device.
Embodiment 14. The computer-implemented method of any one or more of the embodiments, further comprising recalling the transmitted one or more notifications from the user device in view of the updated notification.
Embodiment 15. The computer-implemented method of any one or more of the embodiments, wherein the first source is selected from a group consisting of an image capture device, a wired keypad, a wireless keypad, a wired transmitter, a wireless transmitter, a smart device, a movable barrier operator, a smart lock, a motion detector, and a proximity detector, and wherein the second source is selected from a group consisting of an image capture device, a wired keypad, a wireless keypad, a wired transmitter, a wireless transmitter, a smart device, a movable barrier operator, a smart lock, a motion detector, and a proximity detector.
Embodiment 16. The computer-implemented method of any one or more of the embodiments, wherein the first source comprises a first type of device, and wherein the second source comprises a second type of device different than the first type of device.
Embodiment 17. A non-transitory computer-readable medium storing instructions which, when executed by a processor, cause performance of a method of notifying a user of a consolidated event, the method comprising: receiving a user request to view a feed history including data obtained from one or more sources; displaying the feed history on a user device, the feed history including a consolidated event, wherein the consolidated event comprises a plurality of separately captured events and a consolidated event tag descriptively identifying the consolidated event; receiving a user request to individually access the plurality of separately captured events included in the consolidated event; and expanding the consolidated event to display the separately captured events and consolidated event tags descriptively identifying each of the separately captured events.
Embodiment 18. The non-transitory computer-readable medium of any one or more of the embodiments, wherein displaying the consolidated event on the user device comprises selecting data from the one or more sources to display on the user device, and wherein the selected data comprises one of the plurality of separately captured events having a highest relevance score.
Embodiment 19. The non-transitory computer-readable medium of any one or more of the embodiments, wherein the plurality of separately captured events are arranged in a stack of cards
Embodiment 20. The non-transitory computer-readable medium of any one or more of the embodiments, wherein the data is obtained from a first source, a second source, and a third source, and wherein at least one of the first, second, and third sources comprises an image capture device.
Embodiment 21. A computer-implemented method comprising: displaying, at a display of a user device, a first video feed from a first camera, wherein the first video feed depicts a moving object; receiving, at a user input of the user device, a user request to track the moving object; analyzing, by a processor, the first video feed to identify information associated with the moving object; determining, by the processor, presence of the identified information associated with the moving object in a second video feed from a second camera, the first and second cameras connected to a user network; and displaying, at the display of the user device, a feed history including a consolidated event, wherein the consolidated event comprises at least a portion of the first video feed from the first camera and at least a portion of the second video feed from the second camera, the portions of the first and second video feeds each including the moving object.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A non-transitory computer-readable medium storing instructions which, when executed by a processor, cause performance of a method of notifying a user of a consolidated event, the method comprising:
receiving a first datum from a first source and a second datum from a second source, wherein the first and second sources are both connected to a network;
processing information associated with the first datum to identify an event information associated with the first datum;
processing information associated with the second datum to identify an event information associated with the second datum;
comparing at least a portion of the event information associated with the first datum with at least a portion of the event information associated with the second datum;
determining occurrence of a consolidated event based on the comparing;
determining a notification based on the determined consolidated event; and
causing transmission of the determined notification to a user device.

2. The non-transitory computer-readable medium of claim 1, wherein the method further comprises:
receiving a third datum from a third source, wherein the third source is connected to the user network;
processing information associated with the third datum to identify an event information associated with the third datum; and
comparing at least a portion of the event information associated with the third datum with at least a portion of the event information associated with each of the first and second datum.

3. The non-transitory computer-readable medium of claim 2, wherein the notification identifies a contextual information associated with the determined consolidated event, and wherein a detail level of the contextual information is different based on which combination of the first, second, and third datum is received and processed.

4. The non-transitory computer-readable medium of claim 1, wherein the first source is selected from a group consisting of an image capture device, a wired keypad, a wireless keypad, a wired transmitter, a wireless transmitter, a smart device, a movable barrier operator, a smart lock, a motion detector, and a proximity detector, and wherein the second source is selected from a group consisting of an image capture device, a wired keypad, a wireless keypad, a wired transmitter, a wireless transmitter, a smart device, a movable barrier operator, a smart lock, a motion detector, and a proximity detector.

5. The non-transitory computer-readable medium of claim 4, wherein the first source comprises a first type of device, and wherein the second source comprises a second type of device different than the first type of device.

6. The non-transitory computer-readable medium of claim 1, wherein the event information associated with the first datum and the second datum each includes a contextual information, wherein comparing the event information associated with the first and second datum comprises determining a relatedness of the contextual information associated with the first datum with the contextual information associated with the second datum; and wherein determining occurrence of the consolidated event based on the comparing comprises:
analyzing the relatedness of the contextual information associated with the first and second datum; and
determining a consolidated event type based on the contextual information where the analyzed relatedness exceeds a threshold.

7. The non-transitory computer-readable medium of claim 6, wherein the determined notification is generated by comparing the consolidated event type to a lookup table or content rules.

8. The non-transitory computer-readable medium of claim 1, wherein the method further comprises:
selecting one of the first or second datum in view of a selection criteria; and
causing transmission of at least a portion of the selected datum to the user device.

9. The non-transitory computer-readable medium of claim 1, wherein the first datum is received prior to the second datum, and wherein the method further comprises:
determining the event information associated with the first datum in response to receiving the first datum;
determining a waiting period associated with a duration of time between receiving the first datum and an anticipated receipt of the second datum in view of the determined event information; and
waiting for the waiting period to expire without causing transmission of the determined notification to the user device.

10. The non-transitory computer-readable medium of claim 9, further comprising:
determining a notification based on the event information associated with the first datum; and
causing transmission of the notification based on the event information associated with the first datum after expiration of the waiting period without receipt of the second datum.

11. A computer-implemented method comprising:
receiving, at a processor, a first datum from a first source;
determining, by the processor, a condition for causing transmission of a notification to a user device;
receiving, at the processor, a second datum from the first source or a second source, the second datum received prior to satisfying the condition;
processing, by the processor, information associated with the first datum and information associated with the second datum;
generating, by the processor, one or more notifications to the user device based on the processing; and
causing transmission of the one or more notifications to the user device.

12. The computer-implemented method of claim 11, wherein determining the condition comprises determining a duration of time to wait prior to determining the one or more notifications, and wherein the second datum is received prior to expiration of the duration of time.

13. The computer-implemented method of claim 11, further comprising:
receiving, at the processor, a third datum from the first source, the second source, or a third source, wherein the third datum is received after the condition;
comparing, by the processor, information associated with the third datum with the information associated with the first datum, the second datum, or both; and
determining, by the processor, an updated notification based on the comparing of the third datum with the information associated with the first datum, the second datum, or both;
causing transmission of the updated notification to the user device.

14. The computer-implemented method of claim 13, further comprising recalling the transmitted one or more notifications from the user device in view of the updated notification.

15. The computer-implemented method of claim 11, wherein the first source is selected from a group consisting of an image capture device, a wired keypad, a wireless keypad, a wired transmitter, a wireless transmitter, a smart device, a movable barrier operator, a smart lock, a motion detector, and a proximity detector, and wherein the second source is selected from a group consisting of an image capture device, a wired keypad, a wireless keypad, a wired transmitter, a wireless transmitter, a smart device, a movable barrier operator, a smart lock, a motion detector, and a proximity detector.

16. The computer-implemented method of claim 15, wherein the first source comprises a first type of device, and wherein the second source comprises a second type of device different than the first type of device.

17. A non-transitory computer-readable medium storing instructions which, when executed by a processor, cause performance of a method of notifying a user of a consolidated event, the method comprising:
receiving a user request to view a feed history including data obtained from one or more sources;
displaying the feed history on a user device, the feed history including a consolidated event, wherein the consolidated event comprises a plurality of separately captured events and a consolidated event tag descriptively identifying the consolidated event;
receiving a user request to individually access the plurality of separately captured events included in the consolidated event; and
expanding the consolidated event to display the separately captured events and consolidated event tags descriptively identifying each of the separately captured events.

18. The non-transitory computer-readable medium of claim 17, wherein displaying the consolidated event on the user device comprises selecting data from the one or more sources to display on the user device, and wherein the selected data comprises one of the plurality of separately captured events having a highest relevance score.

19. The non-transitory computer-readable medium of claim 17, wherein the plurality of separately captured events are arranged in a stack of cards

20. The non-transitory computer-readable medium of claim 17, wherein the data is obtained from a first source, a second source, and a third source, and wherein at least one of the first, second, and third sources comprises an image capture device. FEED STITCHING AND GENERATION OF CONSOLIDATED EVENT NOTIFICATIONS
